(19) United States
(12) Patent Application Publication
(10) Pub. No.: US 2010/0017706 A1
(43) Pub. Date: Jan. 21, 2010

(54) DOCUMENT SIZE CONVERSION

(75) Inventor: Fred F. Wilczak, JR., Pittsford, NY (US)

Correspondence Address: Fleit Gibbons Gutman Bongini & Bianco P.L., One Boca Commerce Center, 551 NW 77th Street, Suite 111, Boca Raton, FL, 33487, US

(73) Assignee: Xerox Corporation, Norwalk, CT (US)

(21) Appl. No.: 12/176,438

(22) Filed: Jul. 21, 2008

(51) Int. Cl. G06F 17/21

(52) U.S. Cl. 715/244

(57) ABSTRACT

What is provided is a system and method for resizing documents, for example, from legal size to a standard size. Document sizes are changed by adding or decreasing an amount of white space between lines of text. In one example embodiment, a multi-page document having a specified displayed page size is received. The multi-page document includes a plurality of text lines having respective specified font sizes and respective inter-line spacing. An inter-line spacing value within the current page is determined. The inter-line spacing value within the current page is reduced by a difference in size between the specified displayed page size and a target displayed page size. The font size of the document is retained. If the document size, after changing the amount of white space between lines, still exceeds a predetermined amount, an image magnification technique is used to complete the change in document size.

### TECHNICAL FIELD

The present invention is directed to systems and methods for converting a document from one size to another.

### BACKGROUND

Documents including text or a combination of text and images are often created for a particular specified displayed paper size. For example, a document is able to be created with a specification that it is to be printed on, for example, standard letter sized paper or legal size paper. Additionally, making a copy of a pre-existing hardcopy document implies that the original document will be printed on a pre-determined paper size that may differ from the specified displayed paper size for which the document was created.

Page layouts are often adjusted for a document based on the specified paper size on which the document is intended to be printed. Simply printing the document on another size of paper may have an undesired deleterious effect on the appearance of the document if, for example, line wrapping and page breaks cause unattractive changes to the document. Direct image compression of a printed page often results in, for example, an undesired shrinking of typeface font and/or an increase in page margin.

As paper size usages throughout the world slowly converge on a few standard paper sizes, document conversion techniques must be employed to convert existing documents to the new paper sizes. Converted documents can be stored in any printed page size format, but are often printed on standard sized paper. For example, many users are moving away from legal size documents (8½×14) towards standard letter size (8½×11) paper. When documents stored in legal size are to be resized to, for example, to be printed on standard letter sized paper, the size of the document image is often just reduced to make the image of the text of the original document fit the desired new size. Various techniques are known in the art for document size reduction (or expansion). In one example, such as printing a legal size document onto a hardcopy with a printer that only has standard size paper includes simply resizing the image of each page of the document to fit onto the standard size paper that is available in the printer's bin.

Present methods effectuate image size reduction through, for example, a change in the image's overall magnification. This often degrades the documents appearance by increasing the margins and reducing the font size.

Accordingly, what is needed in this art are increasingly sophisticated systems and methods for converting documents from one size to another such as, for example, from legal size to a standard size.

### BRIEF SUMMARY

What is provided is a novel system, method, and computer program product for converting documents from one size to another such as, for example, from legal size to a standard size. The present method changes document size by adding or decreasing the amount of white space between lines of text. If the amount of white space added or subtracted between lines of the document still exceeds a predetermined amount, then an image magnification technique is used to complete the change in document size.

In one example embodiment, method for adjusting a document's displayed page size includes receiving a multi-page document that is formatted to be displayed with a specified displayed page size. The multi-page document includes a plurality of text lines having respective specified font sizes and respective inter-line spacing. The method further includes determining at least one inter-line spacing value within a current page within the multi-page document. The method additionally includes adjusting the at least one inter-line spacing value within the current page, while retaining the respective font sizes within the current page, to reduce a difference in size between the specified displayed page size and a target displayed page size.

The foregoing and other features and advantages will be apparent from the following more particular description of the embodiments of the invention, as illustrated in the accompanying drawings.

### BRIEF DESCRIPTION OF THE DRAWINGS

The foregoing and other features and advantages of the subject matter disclosed herein will be made apparent from the following detailed description taken in conjunction with the accompanying drawings, in which:

FIGS. 1A and 1B illustrate a received source page and a produced target page, as is processed by one embodiment of the present invention;

FIG. 2 illustrates a page resizing processing flow, in accordance with one embodiment of the present invention; and

FIG. 3 is a block diagram of a computer system useful for implementing one embodiment of the method illustrated in the flow diagram of FIG. 2.

### DETAILED DESCRIPTION

What is provided are a system and method for resizing the displayed or printed portions of each page of a received source document documents so as to cause the displayed portion to conform to a target display page size.

As used herein the term “display” includes any type of text and/or image reproduction, including, for example and without limitation, hardcopy printing of the text and/or image or display on a transitory device such as a computer terminal, user display and the like.

It should be understood that one of ordinary skill in this art would be knowledgeable about computer science and software and programming systems and methods sufficient to implement the functionality and capabilities described in detail herein in their own hardware environments without undue experimentation.

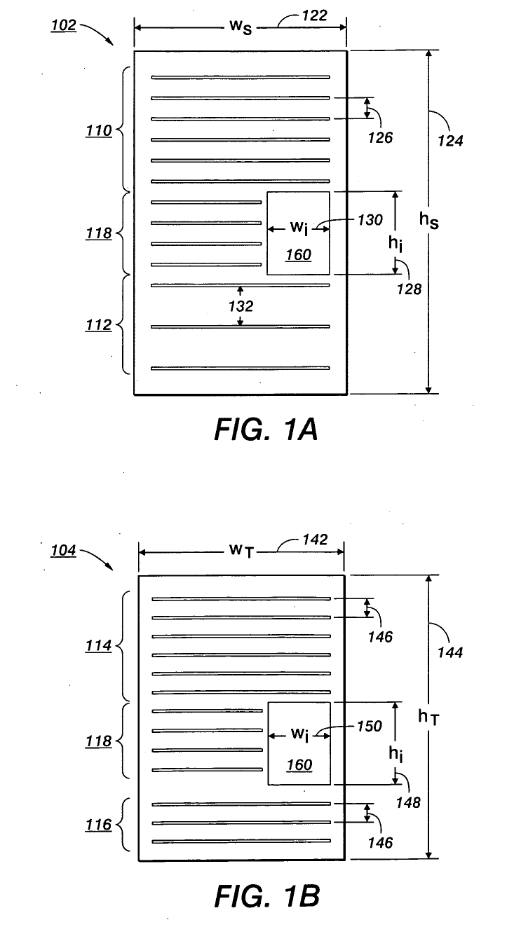

FIGS. 1A and 1B illustrate a received source page and a produced target page 100, as is processed by one embodiment of the present invention. FIG. 1A illustrates a source page 102 in one example is a legal size page with dimensions of eight and one half (8½) inches by fourteen (14) inches. Source page 102 in various embodiments of the present invention is able to be received by, for example, receiving an electronic document file or by scanning a hard copy page. In one embodiment of the present invention, scanning a hard copy page produces a digitized image of the scanned page that can be analyzed and processed to implement the processing of one embodiment of the present invention, as is described below.

The source page 102 has three source text portions, a first source text portion 110, a second source text portion 112, a third source text portion 118, and a graphical image 160. The first source text portion 110 is shown to have a first source inter-line spacing 126. The second source text portion 112 is shown to have a second source inter-line spacing 132. Further examples of the operation of one embodiment of the present invention are able to process source documents that have text portions with either uniform inter-line spacing for an entire page, or documents that have any combination of inter-line spacing in different portions of a page. In the illustrated example, the first source inter-line spacing 110 is able to be, for example, double line spacing and the second source inter-line spacing 112 is able to be triple line spacing.

Text within a source document 102 has an associated font and font size. Various source pages received by one embodiment of the present invention are able to have uniform font sizes or a variety of font sizes at different locations within a page. The font sizes of the source page 102 are referred to as specified respective font sizes since these one or more font sizes are specified for each respective character within the source page. Documents that are received as electronic file are able to specify font sizes as metadata for a document section. Documents received as images, such as the result of an image scanning process, have font sizes specified by the image of each character. Source page 102 is shown to have a graphical image 160. Graphical image 160 is shown to be inserted below the first source text portion 110 and above the second source text portion 112. The graphical image 160 is further embedded within the text of the source document by being to the side of the third source text portion 118. The graphical image 160 has an image width wᵢ 130 and an image height hᵢ 128. Various graphical images 160 are able to be embedded within text or above and/or below various text sections of a particular document. The text spacing of the third source text portion 118 is able to be any size, as is discussed below.

The source page 102 is shown to have a source width wₛ 122 and a source height hₛ 124. In the illustrated example of a legal sized source page 102, the source width wₛ 122 is 8½ inches and the source height hₛ 124 is 14 inches.

The operation of one embodiment of the present invention operates on the data contained within the source page to automatically process the source page data so as to reformat the page and allow for better display, such as printing or a transient display on a user interface, of the data contained on the source page 102. FIG. 1B illustrates an example target page 104. In the illustrated example, the target page 104 has a target width wₜ 142 and a target height hₜ 144. In one example, the target page is a standard letter sized page with a target width wₜ 142 of 8½ inches and a target height hₜ 144 of 11 inches.

In an example of resizing the text content of a legal sized source page 102 to fit within a standard letter sized target page 104, the width of the content is able to be maintained since the source page 102 and the target page 104 both have the same width, i.e., 8½ inches. One embodiment of the present invention operates to compress the area of a display consumed by text portions within the source page by removing vertical whitespace that exists between lines of text on the source page 102.

The target page 104 shows a first target text portion 114 and a second target text portion 116. The textual content of the first target text portion 114 is the same as the textual content of the first source text portion 110. A difference between the first target text portion 114 and the first source text portion 110 is that the inter-line spacing of the first target text portion 114 has been reduced. In one example, the first source text portion 110 contains double spaced text that is reduced to single spaced text in the first target text portion 114. In other words, the first source inter-line spacing 126 corresponds to double spacing and the first target source inter-line spacing 146 corresponds to single spacing. The second target text portion 116 is also contains the same textual content as the first source text portion 112 but with different inter-line spacing. The first source text portion 112 has triple spaced text, while the second text portion 116 is single spaced. In this instance, the second source inter-line spacing 132 corresponds to triple spaced text and the second source inter-line spacing 160 that corresponds to single spacing.

The operation of one embodiment of the present invention allows the contents of a source page 102, which is legal sized with a source height hₛ 124 of 14 inches, to be displayed or printed on a target page 104, which is a standard letter sized sheet with a target height hₜ 144 of 11 inches. The text in such a case is printed on the target page 104 with the same font size as the source page 102, while only the inter-line spacing has been adjusted. Such a reduction in display height allows the target page 104 to be presented with text that is the same size as the source page and with the same side margin sizes as the source page 102. As a result of the reduction in inter-line spacing between the source page 102 and the target page 104, page breaks and size of the text lettering are preserved even as the paper size for the document is changed.

The target page 104 is shown to include the graphical image 160 that corresponds to the graphical image 160 that was included in the source page 102. In one embodiment of the present invention, graphical images are transferred from the source page 102 to the target page 104 without size adjustments. The graphical image 160 is shown to have an image width wᵢ 130 and an image height hᵢ 128 that are the same for both the source page 102 and the target page 104. In an example where the contents of the source page 102 are able to be resized to fit on the target page 104 by only reducing the inter-line spacing of text portions of the source page 102, the size of the original graphical image 160 of the source page 102 is able to be retained in the target page 104. In such a case, as is illustrated for the example received source page and produced target page 100, text that is located on the side of the graphical image 160, such as text within the third source text portion 118, is also able to be transferred to the target page 104 without alteration since it will have the same height in both pages. Further embodiments of the present invention are able to be configured to alter the inter-line spacing of text that is on the side of an image, such as in the third source text portion 118, so as to appear more consistent with other text on the target page. In one example, the inter-line spacing within the third source text portion 118 is able to be adjusted to be equal to the line spacing of one or both of the first target text portion 114 and the second target text portion 116.

Although the above description discusses target page 104 as having inter-line spacing corresponding to single spaced text, one embodiment of the present invention is able to adjust inter-line spacing for the target page 104 to have any value and is not limited to using standard line spacing values. Adjustment of inter-line spacing for the target page 104 is able to be made by various embodiments such that non-integer inter-line spacing is used to create target pages 104 that more evenly use the available vertical space of the page and maximize inter-line white space while fitting the text to the new target page size.

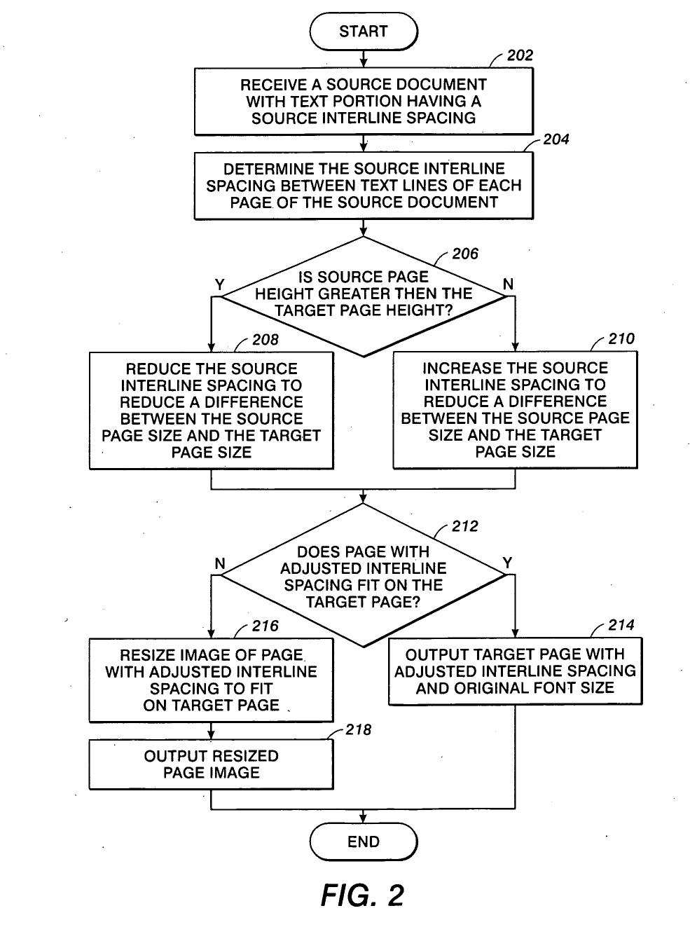

FIG. 2 illustrates a page resizing processing flow 200, in accordance with one embodiment of the present invention. The page resizing processing flow 200 of one embodiment receives one or more pages of a source document and resizes the contents of that document to allow displaying the contents of those pages on target pages. The target pages of one embodiment have a different size than the size specified for the pages of the source document. The size of the target pages is able to be configured prior to operation the page resizing processing flow 200. The page resizing processing flow 200 starts by receiving, at step 202, a source document with text portions, such as the source page 102 described above. The received source document is able to be a single page or a multi-page source document that has a number of text lines with text that has respective specified font sizes and respective inter-line spacing.

Various embodiments of the present invention are able to receive source documents as, for example, electronic files that specify page layouts or the source documents are able to be received by, for example, scanning a hard copy version of the document. As part of a scanning operation, the display page size of the source document corresponds to the hardcopy page being scanned. Documents received in electronic files generally have a specified display or print page size specified as document metadata within or associated with the electronic file.

As described above, the text portions of the received source document have at least one source inter-line spacing. The page resizing processing flow 200 proceeds by determining, at step 204, at least one inter-line spacing value within a current page within the multi-page source document.

One embodiment of the present invention adjusts the determined inter-line spacing value within the source page, while retaining the respective font sizes within the current page, to reduce a difference in size between the specified source page size and the target displayed page size. Reducing a difference between the source page size and the target page size is intended to mean either increasing or decreasing the vertical size of the printed area of the source page. The adjustment of the determined inter-line spacing values to reduce a difference is able to In one embodiment, this adjustment first involves determining inter-line spacing between text lines within the source page. The page resizing processing flow 200 of one embodiment continues by analyzing the received source page to determine, at step 206, if the source page height is greater than a target page height. The target page height used by various embodiments is able to be configured or specified to the page resizing processing flow 200 through any suitable technique. For example, a user interface may allow specification of the target page size, including the height and width of the target page. A processor implementing the page resizing processing flow 200 may further be used as part of a user interface or a printer that outputs displayed or printed pages to pages with a known size. Such known sizes, including the target height and target width, are then used by the page resizing processing flow 200 as the basis for the target page size.

In response to determining that the source page height is greater than the target page height, the processing proceeds to reducing, at step 208, the source inter-line spacing to reduce a difference between the source page size and the target page size. In one example of such a case, a legal size source page is to be resized to be displayed on a letter size display, such as by being printed on a letter size sheet of paper. Where the contents of a legal sized source page is to be displayed on a standard letter sized display, the source width is substantially equal to the target width and the source height is greater than the target height. In this example, proper adjustment of inter-line spacing between text lines of the source page may allow the contents of the source page to be displayed on the target page while retaining the font size or sizes used for the source page.

In response to determining that the source page height is not greater than the target page height, the processing proceeds to increasing, at step 210, the source inter-line spacing to reduce a difference between the source page size and the target page size. This situation could occur, for example, when a source document has a standard letter size page and the target page is a legal size page. Increasing the inter-line spacing of the source text will allow the text of the source page, to more completely fill the legal sized target page without a large area of white space at the bottom of the target page. Such resizing will retain the font size of the source document, which has substantially the same width as the target document, and still retain the line breaks and margin sizes of the source document in the resized target pages.

Once the page resizing processing flow 200 reduces a difference in size between the specified source page size and the target displayed page size by adjusting the determined inter-line spacing values within the source page, while retaining the respective font sizes within the current page, the processing determines, at step 212, if the page with the adjusted inter-line spacing fits on the target page. If the page with the adjusted inter-line spacing is determined to fit on the target page, the target page is output, at step 214, with the adjusted inter-line spacing and the original font size. The processing then ends. If the page with the adjusted inter-line spacing is determined not to fit on the target page, the processing resizes, at step 216, the image of the page with the adjusted inter-line spacing so as to fit on the target page.

Various image resizing techniques are able to be used to make this size adjustment. One example of an image resizing technique that is able to be used to resize the image is to adjust a font size of the text components of the received source page. In conjunction with reducing font sizes, the processing is also able to reduce graphical image sizes by any amount, such as an amount proportional to the reduction in font size. The processing then outputs, at step 218, the resized page image. The processing then ends.

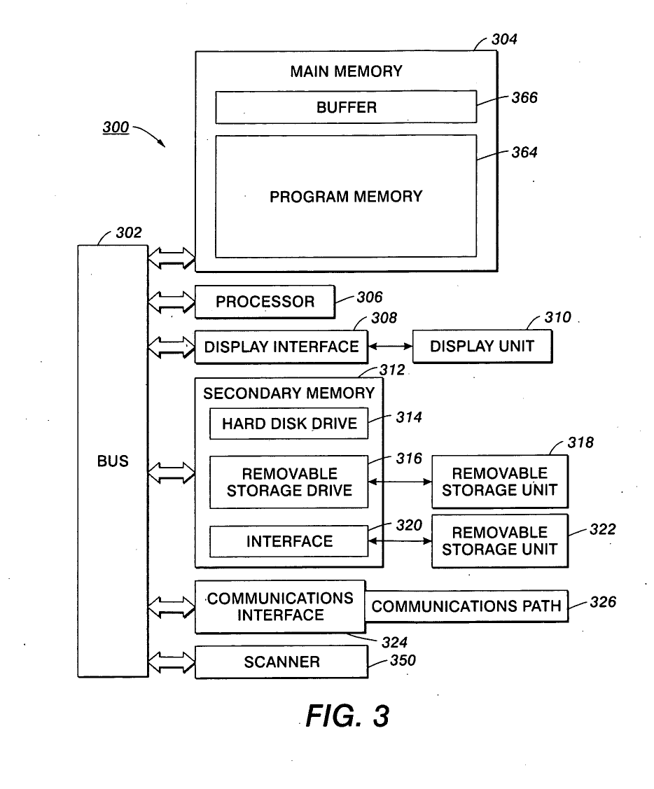

FIG. 3 illustrates a block diagram of one embodiment of a computer system useful for implementing one or more embodiments of the method provided herein.

The computer system 300 can be part of a xerographic system, a photocopier, or printing device. The computer system includes one or more processors, such as processor 306 capable of executing machine executable program instructions. In the embodiment shown, the processor is in communication with bus 302 (e.g., a backplane interface bus, cross-over bar, or data network). The computer system also includes a main memory 304 that is used to store machine readable instructions to be executed by the processor. The main memory is capable of storing data used by or produced by the processor. The main memory may alternatively include random access memory (RAM) to support reprogramming and flexible data storage.

In the embodiment shown, main memory includes buffer 366 to temporarily store data for access by the processor, and a program memory 364 that includes, for example, executable programs that implement the methods described herein. The program memory is capable of storing a subset of the data that is less than all of the data contained in the buffer.

Computer system 300 includes a display interface 308 that forwards data from communication bus 302 (or from a frame buffer not shown) to display 310. Computer system 300 further includes a scanner 350 that is able to scan hard copy documents and produce images in electronic format that facilitate manipulation of the contents of those images. Any marking device or other document reproduction system can be placed in communication with the computer system 300 and thereafter used to output the target page generated in accordance with the present method. Further, the computer system can be integrated, in whole or in part, with the marking device.

The computer system also includes a secondary memory 312. The secondary memory may include, for example, a hard disk drive 314 and/or a removable storage drive 316 which reads and writes to removable storage unit 318, such as a floppy disk, magnetic tape, optical disk, etc., that stores computer software and/or data. In an alternative embodiment, the secondary memory 312 includes other similar mechanisms for allowing computer programs or other instructions to be loaded into the computer system. Such mechanisms may include, for example, a removable storage unit 322 adapted to exchange data through interface 320. Examples of such mechanisms include a program cartridge and cartridge interface (such as that found in video game devices), a removable memory chip (such as an EPROM, or PROM) and associated socket, and other removable storage units and interfaces 320 which allow software and data to be transferred from the removable storage unit to the computer system.

The computer system 300 includes a communications interface 324 which acts as both an input and an output to allow software and data to be transferred between the computer system and external devices. Examples of a communications interface include a modem, a network interface (such as an Ethernet card), a communications port, a PCMCIA slot and card, etc.

Software and data transferred via the communications interface are in the form of signals which may be, for example, electronic, electromagnetic, optical, or other signals capable of being received by communications interface 324. These signals are provided to communications interface via a communications path (i.e., channel) 326 which carries signals and may be implemented using wire, cable, fiber optic, phone line, cellular link, RF, or other communications channels.

Terms such as, computer program medium, computer executable medium, computer usable medium, and computer readable medium, are used herein to generally refer to media such as main memory 304 and secondary memory 312, removable storage drive 316, a hard disk installed in hard disk drive 314, and signals. These computer program products are means for providing instructions and/or data to the computer system. The computer readable medium stores data, instructions, messages packets, or other machine readable information. The computer readable medium, for example, may include non-volatile memory, such as a floppy, ROM, flash memory, disk memory, CD-ROM, and other permanent storage useful, for example, for transporting information, such as data and computer instructions. Furthermore, the computer readable medium may comprise computer readable information in a transitory state medium such as a network link and/or a network interface, including a wired network or a wireless network, that allows a computer to read such computer readable information. Computer programs (also called computer control logic) may be stored in main memory and/or secondary memory. Computer programs may also be received via a communications interface. Such computer programs, when executed, enable the computer system to perform the features and capabilities provided herein.

It should also be understood that the method described in the flowcharts provided herewith can be implemented on a special purpose computer, a micro-processor or micro-controller, an ASIC or other integrated circuit, a DSP, an electronic circuit such as a discrete element circuit, a programmable device such as a PLD, PLA, FPGA, PAL, PDA, and the like. In general, any device capable of implementing a finite state machine that is in turn capable of implementing one or more elements of the flow diagrams provided herewith, or portions thereof, can be used. Portions of the flow diagrams may also be implemented partially or fully in hardware in conjunction with machine executable instructions.

Furthermore, the flow diagrams hereof may be partially or fully implemented in software using object or object-oriented software development environments that provide portable source code that can be used on a variety of computer, workstation, server, network, or other hardware platforms. One or more of the capabilities hereof can be emulated in a virtual environment as provided by an operating system, specialized programs, or from a server.

It should also be understood that the teachings hereof can be implemented in hardware or software using any known or later developed systems, structures, devices, and/or software by those skilled in the applicable art without undue experimentation from the functional description provided herein with a general knowledge of the relevant arts. Moreover, the methods hereof may be readily implemented as software executed on a programmed general purpose computer, a special purpose computer, a microprocessor, or the like. In this case, the methods hereof can be implemented as a routine embedded on a personal computer or as a resource residing on a server or workstation, such as a routine embedded in a plug-in, a printer, a photocopier, a driver, a scanner, a photographic system, a xerographic device, or the like. The methods provided herein can also be implemented by physical incorporation into an image processing, image reproduction, or color management system.

One or more aspects of the methods described herein are intended to be incorporated in an article of manufacture, including one or more computer program products, having computer usable or machine readable media. For purposes hereof, a computer usable or machine readable media is, for example, a floppy disk, a hard-drive, memory, CD-ROM, DVD, tape, cassette, or other digital or analog media, or the like, which is capable of having embodied thereon a computer readable program, one or more logical instructions, or other machine executable codes or commands that implement and facilitate the function, capability, and methodologies described herein. Furthermore, the article of manufacture may be included on at least one storage device readable by a machine architecture or other xerographic or image processing system embodying executable program instructions capable of performing the methodology described herein. Additionally, the article of manufacture may be included as part of a xerographic system, an operating system, a plug-in, or may be shipped, sold, leased, or otherwise provided separately either alone or as part of an add-on, update, upgrade, or product suite.

It will be appreciated that the above-disclosed and other features and functions, or alternatives thereof, may be desirably combined into many other different systems or applications. Various presently unforeseen or unanticipated alternatives, modifications, variations, or improvements therein may become apparent and/or subsequently made by those skilled in the art which are also intended to be encompassed by the following claims. Accordingly, the embodiments set forth above are considered to be illustrative and not limiting. Various changes to the above-described embodiments may be made without departing from the spirit and scope of the invention.

What is claimed is:

1. A method for adjusting a displayed page size, the method comprising:
receiving a source page that is formatted to be displayed with a specified source page size, the source page comprising a plurality of text lines having respective specified font sizes and respective inter-line spacing;
determining at least one inter-line spacing value within the source page;
adjusting the at least one inter-line spacing value within the current page to create a target page, while retaining the respective font sizes within the source page, to reduce a difference in size between the specified source page size and a target displayed page size; and
outputting the target page.

2. The method of claim 1, wherein the adjusting causes the target page to fit within the target displayed page size.

3. The method of claim 1, wherein the specified source page size specifies a standard printed page paper size, and wherein the target displayed page size specifies a different standard printed page paper size.

4. The method of claim 1, wherein the receiving comprises scanning a printed document.

5. The method of claim 1, further comprising reducing, after the adjusting, the respective font sizes within the target page so as to cause the target page to fit within the target displayed page size.

6. The method of claim 5, wherein the current page comprises a combination of text lines and graphical data, and the method further comprises reducing a size of the graphical data by an amount corresponding to a reduction made by the reducing the respective font sizes.

7. The method of claim 1, wherein the specified source page size comprises a source width and a source height,
wherein the target display page size comprises a target width and a target height,
wherein the source width is substantially equal to the target width,
wherein the source height is larger than the target height; and
wherein the adjusting comprises reducing the respective inter-line spacing of the source page so as to cause the target page to fit within the target displayed page size.

8. The method of claim 7, wherein the inter-line spacing of the current page is one of double spaced and triple spaced, and wherein the reducing reduces the inter-line spacing of the source page by one of one line spacing and two line spacing to create the target page.

9. A system for adjusting a document's displayed page size, the system comprising:
a storage medium capable of storing data; and
a processor in communication with said storage medium, said processor capable of executing a machine readable instruction for performing the method of:
receiving a source page that is formatted to be displayed with a specified source page size, the source page comprising a plurality of text lines having respective specified font sizes and respective inter-line spacing;
determining at least one inter-line spacing value within the source page;
adjusting the at least one inter-line spacing value within the current page to create a target page, while retaining the respective font sizes within the source page, to reduce a difference in size between the specified source page size and a target displayed page size; and
outputting the target page.

10. The system of claim 9, wherein the adjusting causes the target page to fit within the target displayed page size.

11. The system of claim 9, wherein the specified source page size specifies a standard printed page paper size, and wherein the target displayed page size specifies a different standard printed page paper size.

12. The system of claim 9, further comprising a scanner adapted to scanning scanning a printed document.

13. The system of claim 9, the method further comprising reducing, after the adjusting, the respective font sizes within the target page so as to cause the target page to fit within the target displayed page size.

14. The system of claim 13, wherein the current page comprises a combination of text lines and graphical data, and the method further comprises reducing a size of the graphical data by an amount corresponding to a reduction made by the reducing the respective font sizes.

15. The system of claim 9, wherein the specified source page size comprises a source width and a source height,
wherein the target display page size comprises a target width and a target height,
wherein the source width is substantially equal to the target width,
wherein the source height is larger than the target height; and
wherein the adjusting comprises reducing the respective inter-line spacing of the source page so as to cause the target page to fit within the target displayed page size.

16. The system of claim 15, wherein the inter-line spacing of the current page is one of double spaced and triple spaced, and wherein the reducing reduces the inter-line spacing of the source page by one of one line spacing and two line spacing to create the target page.

17. A computer program product for adjusting a document's displayed page size, the computer program product comprising:
a computer-usable data carrier storing instructions that, when executed on a computer, cause the computer to perform a method comprising:
receiving a source page that is formatted to be displayed with a specified source page size, the source page comprising a plurality of text lines having respective specified font sizes and respective inter-line spacing;
determining at least one inter-line spacing value within the source page;
adjusting the at least one inter-line spacing value within the current page to create a target page, while retaining the respective font sizes within the source page, to reduce a difference in size between the specified source page size and a target displayed page size; and
outputting the target page.

18. The computer program product of claim 17, wherein the specified source page size comprises a source width and a source height,
wherein the target display page size comprises a target width and a target height,
wherein the source width is substantially equal to the target width,
wherein the source height is larger than the target height; and
wherein the adjusting comprises reducing the respective inter-line spacing of the source page so as to cause the target page to fit within the target displayed page size.

19. The computer program product of claim 17, further comprising reducing, after the adjusting, the respective font sizes within the target page so as to cause the target page to fit within the target displayed page size.

20. The computer program product of claim 19, wherein the current page comprises a combination of text lines and graphical data, and the method further comprises reducing a size of the graphical data by an amount corresponding to a reduction made by the reducing the respective font sizes.
